(19) United States
(12) Patent Application Publication
(10) Pub. No.: US 2019/0392388 A1
(43) Pub. Date: Dec. 26, 2019

(54) LOGISTICS DISTRIBUTION METHOD AND SYSTEM

(71) Applicants: BEIJING JINGDONG SHANGKE INFORMATION TECHNOLOGY CO, LTD., Beijing (CN); BEIJING JINGDONG CENTURY TRADING CO., LTD., Beijing (CN)

(72) Inventor: Ying ZHONG, Beijing (CN)

(73) Assignees: BEIJING JINGDONG SHANGKE INFORMATION TECHNOLOGY CO, LTD., Beijing (CN); BEIJING JINGDONG CENTURY TRADING CO., LTD., Beijing (CN)

(21) Appl. No.: 16/487,243

(22) PCT Filed: Jan. 4, 2018
(86) PCT No.: PCT/CN2018/071338

§ 371 Date: Aug. 20, 2019

(30) Foreign Application Priority Data
Feb. 22, 2017 (CN) 201710098273.8

(51) Int. Cl. G06Q 10/08; H04W 4/35

(52) U.S. Cl. CPC G06Q 10/08355; H04W 4/35; G06Q 10/0833

(57) ABSTRACT

Proposed are a logistics distribution method and system, relating to the field of logistics. A logistics distribution method, including: obtaining a login address and a login time of a user logging in to a platform, wherein the platform includes one or more of a logistics platform, a shopping platform or a third-party platform; and determining a distribution success rate according to the login address and the login time, so as to determine, according to the distribution success rate, whether to perform direct distribution.

### CROSS-REFERENCE TO RELATED APPLICATIONS

This application is based on and claims the benefit of priority to the Chinese patent application No. 201710098273.8 filed on Feb. 22, 2017, which is hereby incorporated by reference in its entirety into the present application.

### TECHNICAL FIELD

The present disclosure relates to the field of logistics, and in particular to a logistics distribution method and system.

### BACKGROUND

In the process of express delivery, there is often a situation where the consignee is not at the delivery address, which affects the success rate of delivery. If the courier directly heads for the delivery address but the consignee is absent and cannot return within a short period of time, the delivery cannot be successful, which will burden the courier and reduce the delivery efficiency.

In order to avoid the failure of delivery, the courier may often make a phone call to the consignee one by one before delivery, to determine whether the consignee is at the delivery address, and then negotiate the delivery time if the consignee is not at the delivery address. However, such handling manner may also affect the delivery efficiency, and raise the cost of express delivery, and may cause unnecessary disturbance to the consignee at the delivery address.

### SUMMARY

According to one aspect of one or more embodiments of the present disclosure, a logistics distribution method is proposed. The logistics distribution method includes: obtaining a login address and a login time of a user logged in to a platform, wherein the platform includes one or more of a logistics platform, a shopping platform, or a third-party platform; and determining a delivery success rate according to the login address and the login time, so as to determine whether to perform direct delivery according to the delivery success rate.

In some embodiments, the login address is a GPS (global positioning system) positioning information when the user logs in to the platform, or is determined according to an IP (Internet Protocol) address information when the user logs in to the platform.

In some embodiments, obtaining the login address and login time of the user logged in to the platform includes: obtaining the GPS positioning information and the login time when the user logs in to the platform; obtaining the IP address information and login time when the user logs in to the platform, and determining a positioning information of the IP address according to the IP address information; determining the last login according to the login time, and determining the GPS positioning information or the positioning information of the IP address upon the last login to the platform as the login address.

In some embodiments, the delivery success rate is determined according to a distance between the login address and a delivery address, and a time difference between the login time and a current time.

In some embodiments, the delivery success rate is determined according to the following formula:

P=(Q/s)*(K/h)

Wherein, P is the delivery success rate, s is the distance, his the time difference, Q is an influence coefficient of the distance, K is an influence coefficient of the time difference; s≥1, h≥1; when the distance is no more than 1 meter, s=1; when the time difference is no more than 1 minute, h=1.

In some embodiments, the logistics distribution method further includes: obtaining users associated with the delivery address to generate a user list; determining the delivery success rate according to the login address and the login time includes: determining a single user delivery success rate of each user according to the login address and the login time of each user in the user list; and determining a maximum of the single-user delivery success rate as the delivery success rate.

In some embodiments, the logistics distribution method further includes: comparing the delivery success rate with a predetermined threshold; prompting to call the user if the delivery success rate is lower than the predetermined threshold; and prompting direct delivery if the delivery success rate is no lower than the predetermined threshold.

According to another aspect of one or more embodiments of the present disclosure, a logistics distribution system is proposed. The logistics distribution system includes: a login information obtaining unit, configured to obtain a login address and a login time of a user logged in to a platform, wherein the platform includes one or more of a logistics platform, a shopping platform, or a third-party platform; and a delivery success rate determining unit, configured to determine a delivery success rate according to the login address and the login time, so as to determine whether to perform direct delivery according to the delivery success rate.

In some embodiments, the login address is a GPS positioning information when the user logs in to the platform, or is determined according to an IP address information when the user logs in to the platform.

In some embodiments, the login information obtaining unit includes: a GPS positioning information obtaining module, configured to obtain the GPS positioning information and the login time when the user logs in to the platform; an IP positioning information obtaining module, configured to obtain the IP address information and the login time when the user logs in to the platform, and determining positioning information of the IP address according to the IP address information; and a recent login determining module, configured to determine the last login according to the login time, and determining the GPS positioning information or the positioning information of the IP address upon the last login to the platform as the login address.

In some embodiments, the delivery success rate determining unit includes: a distance determining module, configured to determine a distance between the login address and a delivery address; a time difference determining module, configured to determine a time difference between the login time and a current time; and a success rate determining module, configured to determine the delivery success rate according to the distance and the time difference.

In some embodiments, the success rate determining module is configured to determine the delivery success rate: according to the following formula:

P=(Q/s)*(K/h)

wherein, P is the delivery success rate, s is the distance, his the time difference, Q is an influence coefficient of the distance, K is an influence coefficient of the time difference; s≥1, h≥1; when the distance is no more than 1 meter, s=1; when the time difference is no more than 1 minute, h=1.

In some embodiments, the logistics distribution system further includes: a user list determining unit, configured to obtain users associated with the delivery address to generate a user list; the login information obtaining unit is configured to obtain the login address and the login time of the last login of each user in the user list to the platform; the delivery success rate determining unit is configured to determine a single user delivery success rate of each user according to the login address and the login time of each user in the user list, and determine a maximum of the single-user delivery success rate as the delivery success rate.

In some embodiments, the logistics distribution system further includes: a judgment prompting unit, configured to compare the delivery success rate with a predetermined threshold; prompt to call the user if the delivery success rate is lower than the predetermined threshold; and prompt direct delivery if the delivery success rate is no lower than the predetermined threshold.

According to a further aspect of one or more embodiments of the present disclosure, a logistics distribution system is provided. The logistics distribution system comprises: a memory; and a processor coupled to the memory, the processor is configured to, based on instructions stored in the memory, carry out the method according to any logistics distribution method mentioned above.

According to a still further aspect of one or more embodiments of the present disclosure, a computer readable storage medium is proposed. The computer readable storage medium on which computer program instructions are stored, wherein the method according to any logistics distribution method mentioned above are implemented when the computer program instructions executed by a processor.

### BRIEF DESCRIPTION OF THE DRAWINGS

The drawings described herein are used to provide a further understanding of the present disclosure and constitute a part of the present disclosure. The illustrative embodiments of the present disclosure as well as the descriptions thereof, which are used for explaining the present disclosure, do not constitute improper definitions on the present disclosure. In the accompanying drawings:

FIG. 1 is a flow chart of some embodiments of the logistics distribution method of the present disclosure.

FIG. 2 is a flow chart of some embodiments of determining a login address and the login time in the logistics distribution method of the present disclosure.

FIG. 3 is a flow chart of other embodiments of the logistics distribution method of the present disclosure.

FIG. 4 is a flow chart of further embodiments of the logistics distribution method of the present disclosure.

FIG. 5 is a schematic view of some embodiments of the logistics distribution system of the present disclosure.

FIG. 6 is a schematic view of some embodiments of a login information obtaining unit in the logistics distribution system of the present disclosure.

FIG. 7 is a schematic view of some embodiments of the delivery success rate determining unit in the logistics distribution system of the present disclosure.

FIG. 8 is a schematic view of other embodiments of the logistics distribution system of the present disclosure.

FIG. 9 is a schematic view of further embodiments of the logistics distribution system of the present disclosure.

FIG. 10 is a schematic view of still further embodiments of the logistics distribution system of the present disclosure.

### DETAILED DESCRIPTION OF THE EMBODIMENTS

The technical solution of the present disclosure is further described in detail by means of the drawings and embodiments.

A flow chart of some embodiments of the logistics distribution method of the present disclosure is shown in FIG. 1.

In step 101, the login address and the login time of the user logged in to a platform are obtained. The platform may be a shopping platform, a logistics platform, or a third-party platform that can obtain login data. The User may log in to the platform via a mobile terminal or a computer, using a Client or a browser. In some embodiments, when the courier chooses to deliver commodities of a certain waybill, the system finds the address information currently required to be delivered to according to the waybill number input by the courier or input by scanning a code, and then determines the consigned user.

In step 102, the delivery success rate is determined according to the login address and the login time such that the courier determines whether to perform direct delivery according to the delivery success rate. In some embodiments, the login address is the login address of the last login time. In some embodiments, if the login address is close to or coincides with the delivery address, and the login time is close to or coincides with the current time, then the user is inferred to be at the delivery address so that there is a high delivery success rate. When there is a high delivery success rate, the courier may directly perform delivery rather than making a call to contact the consignee; if there is a low delivery success rate, the courier may make a call to contact the consignee so as to determine the delivery time.

By way of such method, it is possible to first obtain the latest location information of the user, and then estimates whether the user is located at the delivery address, to obtain the delivery success rate of direct delivery. The courier can decide whether to perform direct delivery according to the delivery success rate, thereby the number of consignees required for phone communication is reduced, and the logistics distribution efficiency is improved.

In some embodiments, if the user logs in to the platform via a mobile terminal which can perform GPS positioning, the login address can be determined by using the GPS positioning information recorded in the background when the user logged in to the platform. Because of the GPS technology has a high penetration rate, such method may directly use the existing data, so that the calculations and requirements for the performance of the system are reduced, and such method will be popularized.

In other embodiments, the IP address information when the user logs in to the platform may be obtained, and the login address is determined according to the IP address information based on the IP positioning technology. The IP positioning technology determines a geographic location of a device by its IP address. The basic principle of IP positioning is to use the name, registration information or time delay information of the IP device to estimate its geographic location. The positioning accuracy of the high-precision IP positioning service can reach 90% with an error within 80 m.

Such method can be adapted to the circumstances of logging via a mobile terminal that cannot perform GPS positioning, or via a computer, or logging using a browser, thereby the scope of application is improved.

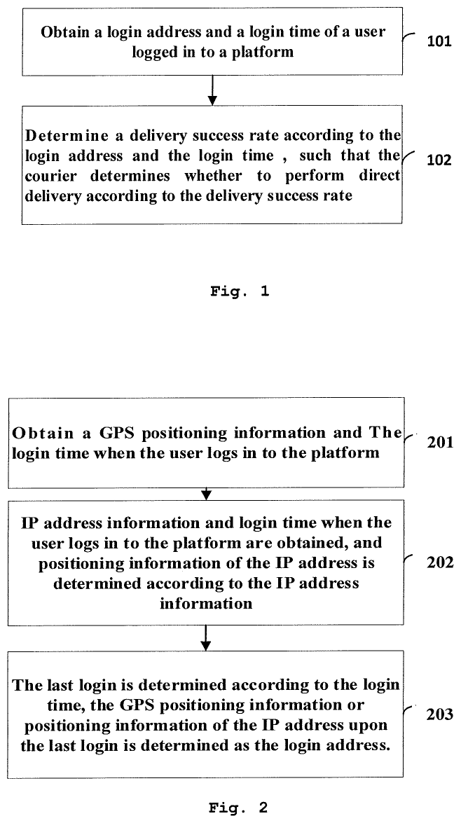

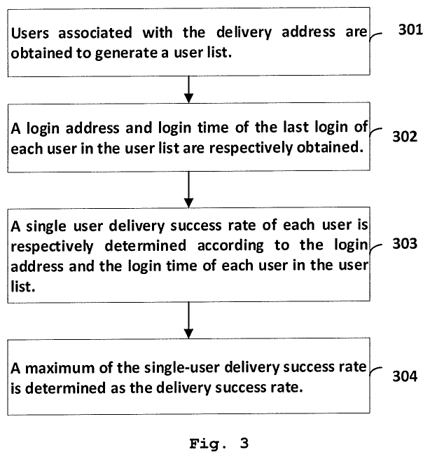

A flow chart of some embodiments of determining the login address and the login time in the logistics distribution method of the present disclosure is shown in FIG. 2.

In step 201, GPS positioning information and login time when the user logged in to the platform are obtained. In some embodiments, it is possible to inquire the GPS positioning information from the database which recorded in the background when the user recently logged into the platform via a mobile app as the GPS positioning information, and to inquire the positioning time as the login time.

In step 202, the IP address information and the login time when the user logged in to the platform are obtained, and positioning information of the IP address is determined according to the IP address information. In some embodiments, it is possible to inquire the IP address information recorded in the background when the user recently logged in via the browser or an APP, and to determine the related geographical position information according to the IP address.

In step 203, the last login is determined according to the login time, then the GPS positioning information or positioning information of the IP address of the last login is determined as the login address, and the login time of the last login is determined, too. In some embodiments, the latest GPS positioning information and the latest IP positioning information are respectively determined according to the login time information, and the login time bound to the latest GPS positioning information is compared with the login time bound to the positioning information of the latest IP address. If the time bound to the GPS positioning information is later, it is determined that the login address is the latest GPS positioning information, and the login time is the login time bound to the latest GPS positioning information. If the time bound to the positioning information of the IP address is later, it is determined that the login address is the positioning information of the latest IP address, and the login time is the login time bound to the latest GPS positioning information.

By such method, it is possible to obtain the login time and the login address closer to the current moment by comparing the login address and the login time of the last login obtained in different manners, thereby the accuracy in calculating the delivery success rate is improved.

In some embodiments, it is possible to determine a distance s between the login address and the delivery address firstly according to the login address; then determine a time difference h between the login time and the current time according to the login time, where the time difference h may be in minutes; and finally determine the delivery success rate according to the distance s and the time difference h. In some embodiments, the calculating formula may be as follows:

P=(Q/s)*(K/h)

wherein, P is the delivery success rate, s is the distance, h is the time difference, Q is the influence coefficient of the distance, K is the influence coefficient of the time difference; s≥1, h≥1; when the distance is no more than 1 meter, s=1; when the time difference is no more than 1 minute, h=1. In some embodiments, the values of the influence coefficients Q, K may be set or adjusted empirically during application and practice, for example Q is 100, K is 30, and the like.

By such method, it is possible to consider the influences of the login address and the login time simultaneously, and the delivery success rate is calculated intuitively and quickly by using the formula, with high calculation efficiency, which is beneficial for popularized application.

In some embodiments, different users may use the same delivery address, for example in the situation that different members in a family possess a plurality of accounts, a successful delivery can be performed when anyone is at home. A flow chart of other embodiments of the logistics distribution method of the present disclosure is shown in FIG. 3.

In step 301, users associated with the delivery address are obtained to generate a user list. In some embodiments, the users who have used the delivery address are all associated with the delivery address, and the association relations between the user IDs and the delivery address may be recorded. The number of users in the user list is no less than 1, that is, at least including the user recorded in the article delivery waybill which the commodity is currently delivery. In some embodiments, when the courier chooses to deliver the commodity of a certain waybill, the system finds the address information currently required to be delivered according to the waybill number input by the courier. The system performs exact matching according to the address information, and then retrieves all the users who have used the address for delivery from the database, and then saves them as a user list.

In step 302, the login address and the login time of the last login of each user in the user list are respectively obtained. To obtain the login address and the login time of the last login of each user, any manner mentioned above may be used.

In step 303, a single user delivery success rate of each user is respectively determined according to the login address and the login time of each user in the user list. In some embodiments, a delivery success rate list may be generated, wherein the respective single-user delivery success rates are included.

In some embodiments, the step 304 may also be included.

In step 304, a maximum of the single-user delivery success rate is determined as the delivery success rate.

By such method, all the users who have used the delivery address can be taken as the consignee. In the case where there is no need to sign in person, it is possible to improve the accuracy in calculating the delivery success rate, and further improve the delivery efficiency.

A flow chart of further embodiments of the logistics distribution method of the present disclosure is shown in FIG. 4.

In step 401, the login address and the login time of the user logged in to the platform for the last time are obtained.

In step 402, the delivery success rate is determined according to the login address and the login time.

In step 403, the delivery success rate is compared with the predetermined threshold (e.g., taking a predetermined threshold of 0.7). If the delivery success rate is lower than the predetermined threshold, the step 404 is performed; if the delivery success rate is no lower than the predetermined threshold, the step 405 is performed. In some embodiments, the predetermined threshold may be set and adjusted according to actual experience.

In step 404, the courier is prompted to call the consignee to determine whether the consignee is convenient to receive the package, or to negotiate the delivery time and position with the consignee.

In step 405, the courier is prompted to perform direct delivery without making a call to contact the consignee.

By such method, it is possible to provide the courier with more intuitive information on whether a call is required to contact the consignee, thus reduce the influence of the subjective judgment of the courier, thereby the accuracy of the judgment is improved.

In some embodiments, when the courier chooses to deliver the commodity of a certain waybill, the system finds the address information currently required to the commodity be delivered to according to the waybill number input by the courier; and performs exact matching according to the address information, and retrieves all the users who have used the address for delivery in the database, and saves them as a user list a.

The system cyclically retrieves the login information of each user in the user list a, which comprises the steps that:

\textcircled{1} The GPS positioning information recorded in the background when each user recently logged in via a mobile APP (Application) is retrieved from the database, and then saved as data ‘b’ if any. In the data ‘b’, the user ID (Identification) is taken as the main key, and the data items of the data include the GPS positioning information and the login time.

\textcircled{2} The IP address information recorded in the background when each user logged in via the browser or the Client recently is retrieved from the database, and then saved as data ‘c’ associated with the user ID of a corresponding user in the user list ‘a’ according to the relevant geographical position information determined by the IP address. In the data ‘c’, the user ID is taken as the main key, and the data items include the position information and the login time.

\textcircled{3} The login time associated with the same user ID in the data ‘b’ and the data ‘c’ are compared, and the data items having recent login time are retained and marked as ‘d’. In the data ‘d’, the user ID is taken as the main key, and the data items include the position information and the login time.

\textcircled{4} After the system retrieves cyclically, the geographic position list ‘e’ is obtained, wherein the list ‘e’ contains the time and geographical position information of the last login of each user in list ‘a’.

After the system has obtained the recent geographic position list ‘e’ of the users, the delivery success rate is calculated, which specifically comprises the steps that:

\textcircled{1} Each item of data in the geographical position list ‘e’ is retrieved cyclically.

\textcircled{2} The distance between each geographical position in the geographical position list and the delivery address is calculated, and marked as s, wherein s≥1, with the distance in meters, and s=1 if the two positions coincide.

\textcircled{3} The time difference between the last login time of the user and the current time is calculated, and marked as h, wherein with the time difference in minutes, and h=1 if both times are the same.

\textcircled{4} The success rate is calculated according to the success rate formula P=Q/s*K/h, where Q and K are self-defining coefficients of the system, which respectively represent the influences of the distance and the login time on the delivery success rate, and are empirical values.

\textcircled{5} After the calculation of the distribution success rates of all the users in the user list is completed, the delivery success rate list ‘f’ of each user is obtained, wherein the list ‘f’ contains the delivery success rate list of each user in the user list under the current delivery address.

Check if there is any value in the list ‘f’ that is greater than the predetermined threshold n. If the list ‘f’ is empty, or all value in list ‘f’ is less than the predetermined threshold ‘n’, the courier will be prompted to manually call the user to inquire if delivery is performed according to predetermined time and address.

By such method, it is possible to obtain the latest position and login time of all the users who have used the current delivery address, and then obtain the delivery success rate corresponding to all the users. In the case where there is no need to sign in person, it is possible to improve the accuracy in calculating the delivery success rate, and further improve the delivery efficiency; and it is possible to implement by using methods such as database retrieval and calculation, which facilitates practical application.

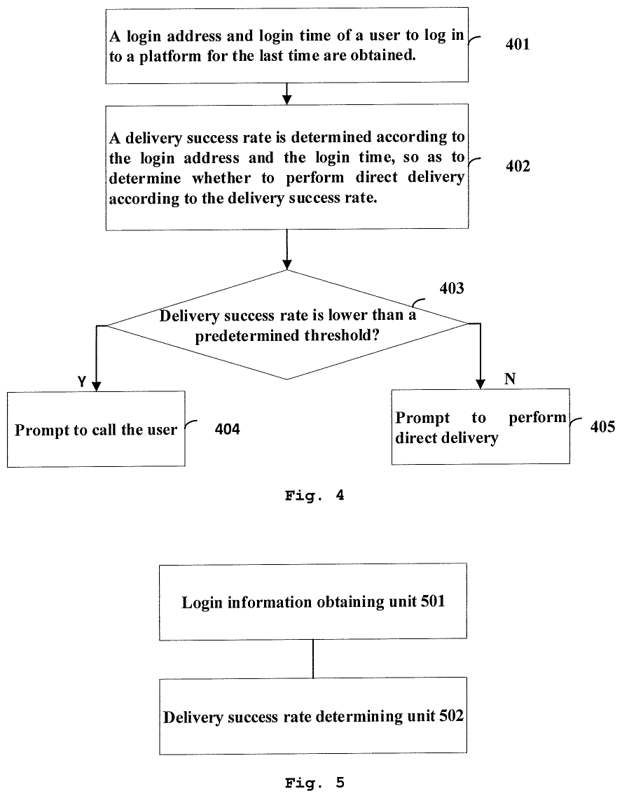

A schematic view of some embodiments of the logistics distribution system of the present disclosure is shown in FIG. 5. The login information obtaining unit 501 can obtain the login address and the login time of the user logged in to the platform. The platform may be a shopping platform, a logistics platform, or a third-party platform that can obtain login data. The User may log in to the platform via a mobile terminal or a computer, using a Client or a browser. In some embodiments, when the courier chooses to deliver the commodity of a certain waybill, the system finds the address information currently required to be delivered to according to the waybill number input by the courier or input by scanning a code, and the determines the consigned user. The delivery success rate determining unit 502 determines a delivery success rate according to the login address and the login time such that the courier determines whether to perform direct delivery according to the delivery success rate. In some embodiments, the login address is the login address corresponding to the last login time. In some embodiments, if the login address is close to or coincides with the delivery address, and the login time is close to or coincides with the current time, then the user is inferred to be at the delivery address so that there is a high delivery success rate. When there is a high delivery success rate, the courier may directly perform delivery rather than making a call to contact the consignee; if there is a low delivery success rate, the courier may make a call to contact the consignee so as to determine the delivery time.

By way of such system, it is possible to first obtain the latest location information of the user, and then estimates whether the user is located at the delivery address, to obtain the delivery success rate of direct delivery. The courier can decide whether to perform direct delivery according to the delivery success rate, thereby the number of consignees required for phone communication is reduced and the logistics distribution efficiency is improved.

In some embodiments, if the user logs in via a mobile terminal, the mobile terminal can perform GPS positioning. The login information obtaining unit 501 may determine the login address by using the GPS positioning information recorded in the background when the user logged in to the platform. Because of the GPS technology has a high penetration rate, the system may directly use the existing data, so that the calculations and requirements for the performance of the system are reduced, and such method will be popularized.

In other embodiments, the login information obtaining unit 501 may obtain the IP address information the user used when the user logged in to the platform, and then determine the login address according to the IP address information based on the IP positioning technology. The IP positioning technology determines a geographic location of a device by its IP address. The basic principle of IP positioning is to use the name, registration information or time delay information of the IP device to estimate its geographic location. The positioning accuracy of the high-precision IP positioning service can reach 90% with an error within 80 m.

Such system can be adapted to the circumstances of logging via a mobile terminal that cannot perform GPS positioning or via a computer, or logging using a browser, thereby the scope of application is improved.

A schematic view of some embodiments of the login information obtaining unit in the logistics distribution system of the present disclosure is shown in FIG. 6.

The GPS positioning information obtaining module 601 may obtain GPS positioning information and the login time of the user logged in to the platform. In some embodiments, it is possible to inquire the GPS positioning information recorded in the background when the user recently logged in to the platform via a mobile app as the GPS positioning information in the database, and to inquire the positioning time as the login time.

The IP positioning information obtaining module 602 may obtain IP address information and the login time when the user logged in to the platform recently, and then determine positioning information of the IP address according to the IP address information. In some embodiments, it is possible to inquire the IP address information recorded in the background when the user recently logged in via the browser or an APP, and then determine the related geographical position information according to the IP address.

The recent login determining module 603 can determine the last login according to the login time, then determine the GPS positioning information or positioning information of the IP address of the last login as the login address, and determine the login time of the last login, too.

In some embodiments, the latest GPS positioning information and the latest IP positioning information are respectively determined according to the login time information, and the login time bound to the latest GPS positioning information is compared with the login time bound to the positioning information of the latest IP address. If the time bound to the GPS positioning information is later, it is determined that the login address is the latest GPS positioning information, and the login time is the login time bound to the latest GPS positioning information. If the time bound to the positioning information of the IP address is later, it is determined that the login address is the positioning information of the latest IP address, and the login time is the login time bound to the latest GPS positioning information.

By such system, it is possible to obtain the login time and the login address closer to the current moment by comparing the login address and the login time of the last login obtained in different manners, thereby the accuracy in calculating the delivery success rate is improved.

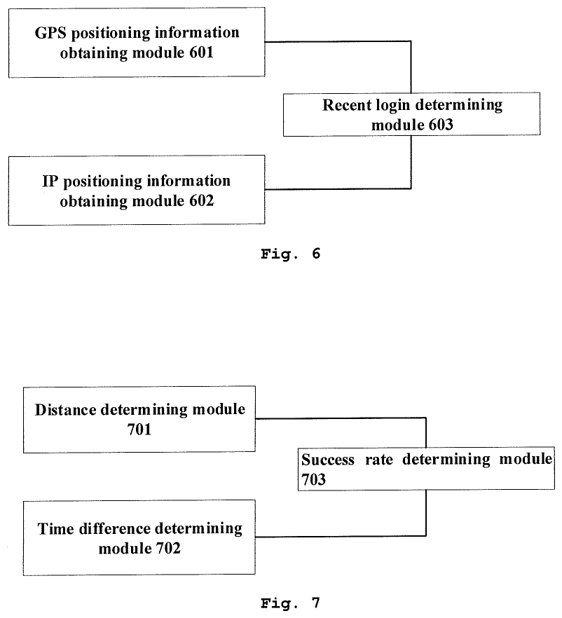

A schematic view of some embodiments of the delivery success rate determining unit in the logistics distribution system of the present disclosure is shown in FIG. 7. The distance determining module 701 can determine the distance s between the login address and the delivery address according to the login address, wherein the distance s may be in meters. The time difference determining module 702 determines the time difference h between the login time and the current time according to the login time, wherein the time difference h may be in minutes, seconds, and the like. The success rate determining module 703 may determine the delivery success rate according to the distance s and the time difference h. In some embodiments, the calculating formula in the success rate determining module 703 may be as follows:

P=(Q/s)*(K/h)

wherein, P is the delivery success rate, s is the distance, h is the time difference, Q is the influence coefficient of the distance, K is the influence coefficient of the time difference; s≥1, h≥1; when the distance is no more than 1 meter, s=1; when the time difference is no more than 1 minute, h=1. In some embodiments, the values of the influence coefficients Q, K may be set or adjusted empirically during application and practice.

By such system, it is possible to consider the influences of the login address and the login time simultaneously, and the delivery success rate is calculated intuitively and quickly by using the formula, with high calculation efficiency, which is beneficial for popularized application.

In some embodiments, different users may use the same delivery address, for example in the situation that different members in a family possess a plurality of accounts, a successful delivery can be performed when any one is at home. A schematic view of other embodiments of the logistics distribution system of the present disclosure is shown in FIG. 8. The user list determining unit 803 can obtain users associated with the delivery address to generate a user list. In some embodiments, the users who have used the delivery address are all associated with the delivery address. In some embodiments, the association relations between the user IDs and the delivery address may be recorded. The number of users in the user list is no less than 1, that is, at least including the user recorded in the article delivery waybill which the commodity is currently delivery. The login information obtaining unit 801 may respectively obtain a login address and the login time of the last login of each user in the user list. The delivery success rate determining unit 802 may respectively determine a single user delivery success rate of each user according to the login address and the login time of each user in the user list. In some embodiments, the delivery success rate determining unit 802 may also determine a maximum of the single-user delivery success rate as the delivery success rate.

By such system, all the users who have used the delivery address can be taken as the consignee. In the case where there is no need to sign in person, it is possible to improve the accuracy in calculating the delivery success rate, and further improve the delivery efficiency.

In some embodiments, as shown in FIG. 8, the logistics distribution system further comprises the judgment prompting unit 804, which can compare the delivery success rate with the predetermined threshold. If the delivery success rate is lower than the predetermined threshold, the courier is prompted to call the consignee to determine whether the consignee is convenient to receive the package, or to negotiate the delivery time and location with the consignee. If the delivery success rate is no lower than the predetermined threshold, the courier is prompted to perform direct delivery without making a call to contact the consignee. In some embodiments, the predetermined threshold may be set and adjusted according to actual experience. In some embodiments, if the user list includes a plurality of users, the judgment prompting unit 804 may respectively compare the respective single-user delivery success rates with the predetermined threshold, and in the case that all the single-user delivery success rates are lower than the predetermined threshold, the courier is prompted to call the user to determine whether the consignee is convenient to receive the package, or to negotiate the delivery time and location with the consignee.

By such system, it is possible to provide the courier with more intuitive information on whether a call is required to contact the consignee, thus reduce the influence of the subjective judgment of the courier, thereby the accuracy of the judgment is improved.

In some embodiments, the logistics distribution system may be located in the server. The server receives the scanned information or input information of an express delivery waybill from the terminal (such as a dedicated device, a mobile phone, etc.) of the courier, and determines the delivery address and the relevant user of the express delivery waybill; and returns the obtained delivery success rate to the terminal of the courier. Such system need not update the terminal devices, so that the operating cost is reduced, and the application is facilitated expanded.

In some other embodiments, the logistics distribution system may be designed in the form of a terminal. The terminal initiates a retrieval to the database according to the scanned information or input information of the express delivery waybill, and then calculates the delivery success rate according to the feedback information. Such system places the arithmetic processing on the terminal side, thereby the computing performance of the existing terminal is made full use, and the burden on the server is reduced.

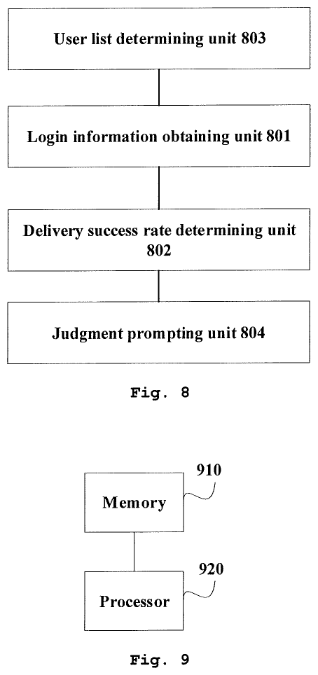

A schematic structural view of some other embodiments of the logistics distribution system of the present disclosure is shown in FIG. 9. The logistics distribution system comprises a memory 910 and a processor 920, wherein: the memory 910 may be a magnetic disk, a flash memory, or any other non-volatile storage medium. The memory is configured to store instructions in a corresponding embodiment of the logistics distribution method. The processor 920 which is coupled to the memory 910, may be implemented as one or more integrated circuits, such as a microprocessor or a microcontroller. The processor 920 which is configured to execute instructions stored in the memory, can implement determining the delivery success rate.

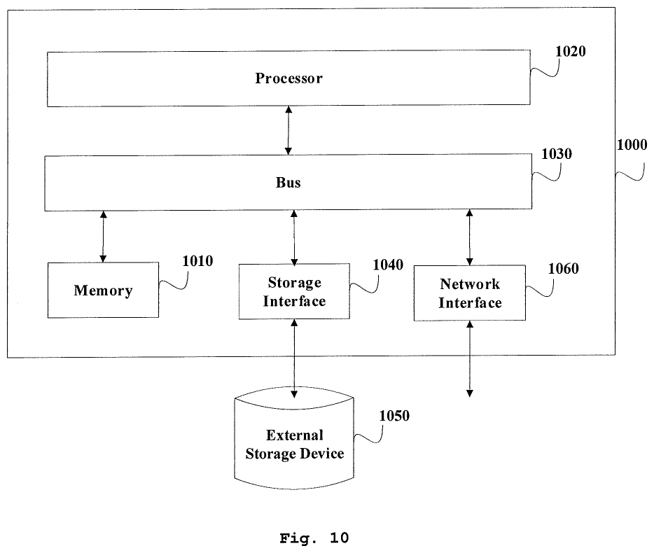

In some embodiments, it may also be that, as shown in FIG. 10, the logistics distribution system 1000 comprises a memory 1010 and a processor 1020. The processor 1020 is coupled to the memory 1010 via a bus 1030. The logistics distribution system 1000 may also be connected to the external storage device 1050 via a storage interface 1040 for calling external data, and may also be connected to the network or another computer system (not shown) via the network interface 1060. It will not be introduced in detail here.

In this embodiment, data instructions are stored by the memory, and then the above-described instructions are processed by the processor, so that the delivery success rate can be efficiently obtained.

In other embodiments, a computer readable storage medium is further proposed. The computer readable storage medium has stored thereon computer program instructions which, when executed by a processor, implement the steps of the method in the corresponding embodiments of the logistics distribution method. Those skilled in the art will appreciate that the embodiments of the present disclosure may be provided as a method, device, or computer program product. Accordingly, the present disclosure may take the form of an entirely hardware embodiment, an entirely software embodiment, or a combination of software and hardware aspects. Moreover, the present disclosure may take the form of a computer program product embodied in one or more computer-usable non-transitory storage media (including but not limited to disk memory, CD-ROM, optical memory, and the like) containing computer usable program codes therein.

The present disclosure is described with reference to the flow charts and/or block diagrams of methods, devices (systems), and computer program products according to the embodiments of the present disclosure. It will be understood that each step and/or block of the flow charts and/or block diagrams as well as a combination of steps and/or blocks of the flow charts and/or block diagrams may be implemented by a computer program instruction. These computer program instructions may be provided to a processor of a general purpose computer, special purpose computer, an embedded processing machine, or other programmable data processing devices to produce a machine, such that the instructions executed by a processor of a computer or other programmable data processing devices produce a device for realizing a function designated in one or more steps of a flow chart and/or one or more blocks in a block diagram.

These computer program instructions may also be stored in a computer readable memory that can guide a computer or other programmable data processing device to operate in a particular manner, such that the instructions stored in the computer readable memory produce a manufacture including an instruction device. The instruction device realizes a function designated in one or more steps in a flow chart or one or more blocks in a block diagram.

These computer program instructions may also be loaded onto a computer or other programmable data processing devices, such that a series of operational steps are performed on a computer or other programmable device to produce a computer-implemented processing, such that the instructions executed on a computer or other programmable devices provide steps for realizing a function designated in one or more steps of the flow chart and/or one or more blocks in the block diagram.

Heretofore, the present disclosure has been described in detail. Some details well known in the art are not described to avoid obscuring the concept of the present disclosure. According to the above description, those skilled in the art would fully know how to implement the technical solutions disclosed herein.

The method and device of the present disclosure may be implemented in many manners. For example, the method and device of the present disclosure may be implemented by a software, hardware, firmware, or any combination of a software, hardware, and firmware. The above-described sequence of steps for the method is for illustrative purposes only, and the steps of the method of the present disclosure are not limited to the sequence specifically described above unless otherwise specifically stated. Moreover, in some embodiments, the present disclosure may also be embodied as programs recorded in a recording medium, which include machine readable instructions for implementing the method according to the present disclosure. Thus, the present disclosure also covers a recording medium storing programs for performing the method according to the present disclosure.

Finally, it should be explained that: the aforementioned embodiments are only used to describe the technical solution of the present disclosure rather than limiting the same; although detailed explanations are made to the present disclosure by referring to preferred embodiments, a common technical person in the art should understand that: it is still possible to make amendments to the embodiments of the present disclosure or make equivalent replacements to part of the technical features; without departing from the spirit and scope of the present disclosure, they should all be covered in the scope of the technical solution for which protection is sought in the present disclosure.

1.-15. (canceled)

16. A computer-implemented logistics distribution method, comprising:
obtaining a login address and a login time of a user logged in to a platform, wherein the platform comprises one or more of a logistics platform, a shopping platform, or a third-party platform; and
determining a delivery success rate according to the login address and the login time, so as to determine whether to perform direct delivery according to the delivery success rate.

17. The computer-implemented logistics distribution method according to claim 16, wherein the login address is a global positioning system GPS positioning information when the user logs in to the platform, or is determined according to an Internet Protocol IP address information when the user logs in to the platform.

18. The computer-implemented logistics distribution method according to claim 16, wherein obtaining the login address and the login time of the user to log in to the platform comprises:
obtaining a GPS positioning information and the login time when the user logs in to the platform;
obtaining an IP address information and the login time when the user logs in to the platform, and determining a positioning information of the IP address according to the IP address information;
determining the last login according to the login time, and determining the GPS positioning information or the positioning information of the IP address corresponding to the last login to the platform as the login address.

19. The computer-implemented logistics distribution method according to claim 16, wherein the delivery success rate is determined according to a distance between the login address and a delivery address, and a time difference between the login time and a current time.

20. The computer-implemented logistics distribution method according to claim 19, wherein the delivery success rate is determined according to the following formula:
P=(Q/s)*(K/h)
wherein, P is the delivery success rate, s is the distance, h is the time difference, Q is an influence coefficient of the distance, K is an influence coefficient of the time difference; s≥1, h≥1; when the distance is no more than 1 meter, s=1; when the time difference is no more than 1 minute, h=1.

21. The computer-implemented logistics distribution method according to claim 16, further comprising:
obtaining users associated with the delivery address to generate a user list;
determining the delivery success rate according to the login address and the login time comprises:
determining a single user delivery success rate of each user according to the login address and the login time of each user in the user list;
determining a maximum of the single-user delivery success rate as the delivery success rate.

22. The computer-implemented logistics distribution method according to claim 16, further comprising:
comparing the delivery success rate with a predetermined threshold by a computing element;
prompting to call the user if the delivery success rate is lower than the predetermined threshold; and
prompting direct delivery if the delivery success rate is no lower than the predetermined threshold.

23. A logistics distribution system, comprising:
a memory; and
a processor coupled to the memory, which is configured to, based on instructions stored in the memory:
obtain a login address and a login time of a user logged in to a platform, wherein the platform comprises one or more of a logistics platform, a shopping platform, or a third-party platform; and
determine a delivery success rate according to the login address and the login time, so as to determine whether to perform direct delivery according to the delivery success rate.

24. The logistics distribution system according to claim 23, wherein the login address is a global positioning system GPS positioning information when the user logs in to the platform, or is determined according to an Internet Protocol IP address information when the user logs in to the platform.

25. The logistics distribution system according to claim 23, wherein the processor is further configured to:
obtain a GPS positioning information and the login time when the user logs in to the platform;
obtain an IP address information and the login time when the user logs in to the platform, and determine a positioning information of the IP address according to the IP address information;
determine the last login according to the login time, and determining the GPS positioning information or the positioning information of the IP address corresponding to the last login to the platform as the login address.

26. The logistics distribution system according to claim 23, wherein the delivery success rate is determined according to a distance between the login address and a delivery address, and a time difference between the login time and a current time.

27. The logistics distribution system according to claim 26, wherein the delivery success rate is determined according to the following formula:
P=(Q/s)*(K/h)
wherein, P is the delivery success rate, s is the distance, h is the time difference, Q is an influence coefficient of the distance, K is an influence coefficient of the time difference; s≥1, h≥1; when the distance is no more than 1 meter, s=1; when the time difference is no more than 1 minute, h=1.

28. The logistics distribution system according to claim 23, wherein the processor is further configured to:
obtain users associated with the delivery address to generate a user list;
determine the delivery success rate according to the login address and the login time comprises:
determine a single user delivery success rate of each user according to the login address and the login time of each user in the user list;
determine a maximum of the single-user delivery success rate as the delivery success rate.

29. The logistics distribution system according to claim 23, wherein the processor is further configured to:
compare the delivery success rate with a predetermined threshold;
prompt to call the user if the delivery success rate is lower than the predetermined threshold; and
prompt direct delivery if the delivery success rate is no lower than the predetermined threshold.

30. A computer readable storage medium storing a computer program that, when being executed by a processor, implement method for performing operations comprising:
obtaining a login address and a login time of a user logged in to a platform, wherein the platform comprises one or more of a logistics platform, a shopping platform, or a third-party platform; and
determining a delivery success rate according to the login address and the login time, so as to determine whether to perform direct delivery according to the delivery success rate.

31. The computer readable storage medium according to claim 30, wherein the login address is a global positioning system GPS positioning information when the user logs in to the platform, or is determined according to an Internet Protocol IP address information when the user logs in to the platform.

32. The computer readable storage medium according to claim 30, wherein obtaining the login address and the login time of the user to log in to the platform comprises:
obtaining a GPS positioning information and the login time when the user logs in to the platform;
obtaining an IP address information and the login time when the user logs in to the platform, and determining a positioning information of the IP address according to the IP address information;
determining the last login according to the login time, and determining the GPS positioning information or the positioning information of the IP address corresponding to the last login to the platform as the login address.

33. The computer readable storage medium according to claim 30, wherein the delivery success rate is determined according to a distance between the login address and a delivery address, and a time difference between the login time and a current time.

34. The computer readable storage medium according to claim 30, further comprising: obtaining users associated with the delivery address to generate a user list;
determining the delivery success rate according to the login address and the login time comprises:
determining a single user delivery success rate of each user according to the login address and the login time of each user in the user list;
determining a maximum of the single-user delivery success rate as the delivery success rate.

35. The computer readable storage medium according to claim 30, the method further comprising:
comparing the delivery success rate with a predetermined threshold;
prompting to call the user if the delivery success rate is lower than the predetermined threshold; and
prompting direct delivery if the delivery success rate is no lower than the predetermined threshold.
